(19) United States
(12) Patent Application Publication
(10) Pub. No.: US 2016/0029813 A1
(43) Pub. Date: Feb. 4, 2016

(54) INFANT CAR SEAT

(71) Applicants: Krystal Kast, Rockford, IL (US); Senteenio Jones, SR., Rockford, IL (US); Regina Talbert, Rockford, IL (US)

(72) Inventors: Krystal Kast, Rockford, IL (US); Senteenio Jones, SR., Rockford, IL (US); Regina Talbert, Rockford, IL (US)

(21) Appl. No.: 14/718,232

(22) Filed: May 21, 2015

Related U.S. Application Data
(60) Provisional application No. 62/032,729, filed on Aug. 4, 2014.

(51) Int. Cl. A47D 1/06; A47C 7/66; B62B 7/00; B60N 2/28

(52) U.S. Cl. CPC A47D 1/06; B60N 2/2845; B60N 2/2821; A47C 7/66; B62B 7/006

(57) ABSTRACT

An infant safety seat that includes a base which supports the infant seat. A handle extends over the top of the base, where the handle is preferably pivotable. A sun visor and a sun screen extending from the sun visor completely covers a seat opening. A plurality of hook and loop connectors are used to secure the sun screen in a stationary position over the opening. At least two retractable legs extend from the base to provide vertical support for the infant seat when in an extended position where wheels are attached to each leg to enable mobility of the seat. The infant safety seat according to the present invention may also further include a wheel release button that releases the wheels.

### CROSS REFERENCE TO OTHER APPLICATIONS

This application claims priority to U.S. Provisional Application Ser. No. 62/032,729 filed on Aug. 4, 2014.

### BACKGROUND OF THE INVENTION

1. Field of Invention

The present invention relates to a convertible infant car seat that includes wheels for maneuvering the car seat to and from a vehicle.

2. Description of Related Art

Infant seats are designed to protect children while transporting the children in a vehicle. The seats are deigned to restrain the child within the seat in a comfortable position and the seat is usually restrained within the normal vehicle seat. Many times child safety seats are connected to the seatbelts that are available in the seat. Most states require infant safety seats as mandatory equipment when a child is traveling in a vehicle. The infant safety seat is therefore an effective and recognized device to protect an infant or child while transporting the child in a vehicle. One drawback to the infant safety seat is the requirement to remove the seat and transport the seat itself to and from the vehicle or in some instances between vehicles due to a limited number of infant safety seats that an individual may have available. Typically a family has a sufficient number of infant seats for one vehicle and may transport the infant seats from vehicle to vehicle in order to transport the infant. Sometimes the seats can be heavy and cumbersome to maneuver between vehicles or to simply remove from the vehicle to allow other passengers or other luggage to be placed in the vehicle. Consequently it would be advantageous to have a mechanism integrated within the infant safety seat for transporting the seat itself or as an alternative transporting the infant along with the seat.

### SUMMARY OF THE INVENTION

The present invention relates to an infant safety seat that includes a base which supports the infant seat. A handle extends over the top of the base, where the handle is preferably pivotable. A sun visor and a sun screen extending from the sun visor completely covers a seat opening. A plurality of hook and loop connectors are used to secure the sun screen in a stationary position over the opening. At least two retractable legs extend from the base to provide vertical support for the infant seat when in an extended position where wheels are attached to each leg to enable mobility of the seat. The infant safety seat according to the present invention may also further include a wheel release button that releases the wheels.

### BRIEF DESCRIPTION OF DRAWINGS

FIG. 1 depicts a side view of an infant seat in accordance with the present invention.

FIG. 2 depicts a side view of the infant safety seat depicting an integrated wheel system and sun screening capabilities.

### DETAILED DESCRIPTION

The present invention relates to an infant safety seat that includes integrated wheeling wheels that are deplorable through mechanisms in the safety seat. While the safety seat is being used in a vehicle to transport an infant the wheels are placed in a hidden compartment within the seat container of the infant seat. These wheels may be released and deployed to support the safety seat over a flat surface. The infant's safety seat may then be maneuvered by pushing the seat with the use of a handle provided with the infant safety seat. An additional feature of the infant safety seat is a sun visor and sun screening capabilities that allow a user to shield the infant from UV rays while being transported in the seat when the wheels are deployed.

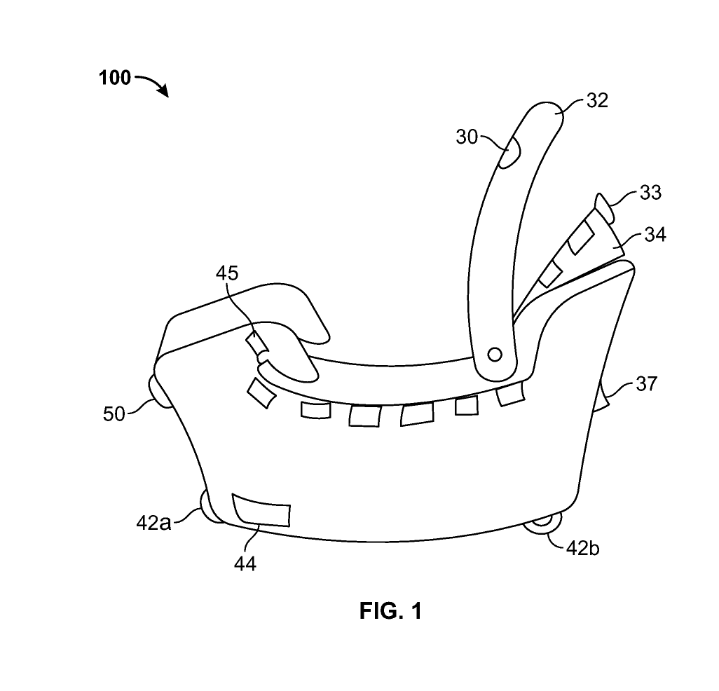

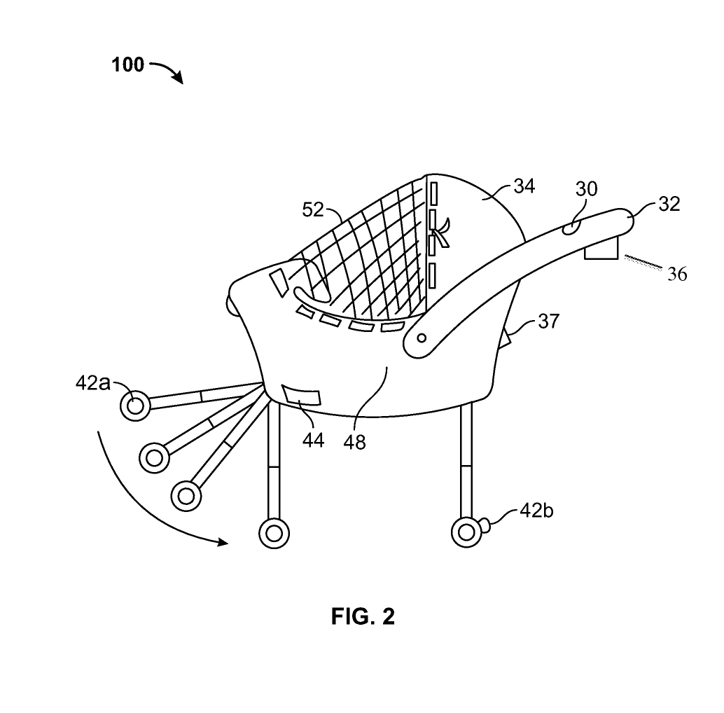

In reference to FIG. 1, an infant safety seat 100 is depicted. The infant safety seat 100 includes a number of features as seen in this side view, wheels 42a, 42b are shown on the underside of the infant safety seat 100. These wheels 42a, 42b are in a stored position and therefore are inoperable in this particular configuration. The depiction of the infant safety seat 100 in FIG. 1 is the general format for use when in a vehicle. Features of the infant safety seat 100 include a handle 32, which pivots to provide functional support for the infant safety seat 100. The handle 32 also includes a wheel release button 30 that releases the wheels 42a, 42b for use when pushing the infant safety seat 100 over a flat surface. Additional features of the infant safety seat 100 include a sun visor 34, which is in a closed position as shown in FIG. 1. Further hook and loop connectors 33, 45 are shown which are used to place a visor screen 52, shown in FIG. 2 over the opening of the infant safety seat 100.

Another handle 37 is provided on a back side of the infant safety seat 100. Further a solar powered light 50 is on a front side of the infant safety seat 100. Also on the side panel of the infant safety seat 100 is a reflector 44. These additional features are useful when the wheels 42a, 42b are deployed and the infant safety seat 100 may be pushed over a flat surface.

FIG. 2 depicts the infant safety seat 100 where wheels 42a, and 42b are fully extended and provide vertical support for the infant safety seat 100. The front wheel 42a is rotatable and adjustable at an angle to provide various positioning to function while the infant safety seat 100 is maneuvered and a rear wheel 42b is provided as a further support of the infant safety seat 100. When in this deployed position, the handle 32 is pivoted behind the infant safety seat 100 to provide a push handle mechanism to maneuver the infant safety seat 100. When pivoted forward the handle 32 can be used to lift and carry the safety seat. Also, extending below the handle 32 is a cup holder 36. A user can use the cup holder 36 to transport a beverage during use of the infant safety seat 100.

Locks although not shown are available on the wheels to lock the infant's safety seat 100 in a stationary position when the wheels 42a, and 42b are deployed. This versatile infant safety seat eliminates the need to actually carry the seat and alternatively serves as an infant carriage when the wheels are deployed to enable the user to transport their children within the infant safety seat. The instant invention has been shown and described in what it considers to be the most practical and preferred embodiments. It is recognized, however, that departures may be made there from within the scope of the invention and that obvious modifications will occur to a person skilled in the art.

What is claimed is:

1. An infant safety seat comprising:
a. a base, the base supports an infant seat;
b. a handle extending over the top of the base;
c. a sun visor;
d. a sun screen extending from the sun visor, where the sun screen completely covers a seat opening;
e. a plurality of hook and loop connectors to secure the sun screen in a stationary position;
f. at least two legs, where the at least two legs retract into the base in a retracted position and extend from the base to provide vertical support for the infant seat when in an extended position; and
g. wheels attached to each leg, where the wheels the wheels enable mobility of the infant safety seat.

2. The infant safety seat according to claim 1, where the handle is pivotable.

3. The infant safety seat according to claim 1, further including a wheel release button that releases the wheels.

4. The infant safety seat according to claim 1, where the sun visor is retractable.

5. The infant safety seat according to claim 1, further including a handle on a back side of the infant safety seat.

6. The infant safety seat according to claim 1, further including a solar powered light on a front side of the seat.

7. The infant safety seat according to claim 1, wherein one of the wheels is a front wheel, where the front wheel is rotatable and adjustable at an angle.

8. The infant safety seat according to claim 1, further including a cup holder extending from the handle.
